(19) United States
(12) Patent Application Publication
(10) Pub. No.: US 2026/0263972 A1
(43) Pub. Date: Sep. 10, 2026

(54) EFFLUENT FILTRATION OF A WASHING MACHINE THROUGH A HELICAL BRUSH

(71) Applicant: MANN+HUMMEL Life Sciences & Environment Holding Singapore Pte. Ltd., Singapore (SG)

(72) Inventors: Sonia LORENTE, Zaragoza (ES); Laura DEL RIO, Longares (ES); Ignacio ESTEBAN, Zaragoza (ES); Jaime GRACIA HERAS, Zaragoza (ES); Raúl BIELSA, Zaragoza (ES); Leopoldo MARZAL, Zaragoza (ES)

(21) Appl. No.: 19/663,948

(22) Filed: Apr. 30, 2026

Related U.S. Application Data
(63) Continuation of application No. PCT/IB2024/060579, filed on Oct. 28, 2024.

(30) Foreign Application Priority Data
Nov. 15, 2023 (EP) 23383164

(51) Int. Cl. B01D 29/25

(52) U.S. Cl. CPC B01D 29/25; B01D 2201/0469; B01D 2201/306; B01D 2221/02

(57) ABSTRACT

A filter for effluent of washing machines includes a helical flow channel. A brush extends along the flow channel and is contained within a filter tube. The brush may be replaced, while the filter tube may be reused with a new brush. The brush and the filter tube capture fibers and particles such as microplasics, when effluent is fed through the flow channel. A support unit may at least partially define a cross section of the flow channel. In an mebodiment the support unit is detachably arranged in a housing of a filter module.

### CROSS-REFERENCE TO RELATED APPLICATIONS

This application is a continuation application of international application No. PCT/IB2024/060579 having an international filing date of October 28, 2024, and designating the United States, the international application claiming a priority date of November 15, 2023, based on European patent application No. 23383164.3, the entire contents of the aforesaid applications being incorporated herein by reference to the fullest extent permissible.

### TECHNICAL FIELD

The present invention relates to a filter assembly for filtering effluent of a washing machine.

### BACKGROUND

When clothing is being washed, fibers and debris are released. Since clothing is often made with synthetic fibers, a certain amount of microplastics is generated during each washing cycle. Nowadays, microplastics emission is frequently considered as a severe ecological problem.

If the fibers and microplastics shall not be released into the environment, they need to be held back in order to be suitably disposed. To this end, the use of filters is generally known, for instance from WO 2021/070102 A1.

US 2019/0126326 A1 discloses a fiber catcher for removing fibers, microfibers, hair and similar items from fluids, such as may be found in effluent pipes, streams, washing machines and clothes dryers. The fiber catcher includes a plurality of arms with a plurality of teeth for collecting fibers that are suspended in fluids. The fiber catcher is generally spherical. For use, the fiber catcher is placed in a drum of the washing machine together with clothing being washed.

CN 110685127 A describes a filtering device for use in a washing machine. The filtering device includes a first base body and a tentacle unit movably disposed on the first base body. The tentacle unit includes a plurality of tentacles configured to adsorb particles in the medium to be filtered. The filter device is generally spherical, elliptical or disk-shaped. The washing machine includes an inner cylinder and a circulation filtration system. The circulation filtration system includes a circulation pipeline, a circulation pump and a filter box. Both ends of the circulation pipeline are connected to the inner cylinder. The circulation pump and the filter box are arranged on the circulation pipeline. The filter device is placed in the filter box. The circulation pump pumps the wash water in the inner barrel to the filter box. After the filter device in the filter box has filtered the wash water, the wash water is returned to the inner barrel. This reciprocating cycle circulates the wash water in the inner barrel. The filter device may be removed from the filter box through a door cover and may be manually cleaned.

It is an object of the invention to provide efficient filtration of effluent of washing machines requiring little maintenance effort.

This is achieved by a filter assembly according to the invention, a filter module according to the invention, the use of a filter module according to the invention and a washing machine including the filter module. Embodiments are given in the following description in conjunction with the accompanying drawings.

### SUMMARY

The filter assembly comprises a support unit having a support tube, which provides a helical flow channel. Typically, the support tube delimits the flow channel over at least part of its longitudinal and/or circumferential extension. The flow channel has a first end and a second end. The first end of the flow channel constitutes an inlet for effluent to be filtered while passing through the flow channel. The second end of the flow channel constitutes an outlet for at least part of the effluent having been filtered while passing through the flow channel. The flow channel generally forms at least 2, for example at least 3 convolutions.

The filter assembly further comprises a brush, which is detachably arranged in the helical flow channel. The brush extends along the flow channel over at least part of the longitudinal extension of the flow channel from the first end towards the second end. The elongated brush generally comprises a multitude of bristles. The brush may span over part of the cross section of the flow channel or the entire cross section of the flow channel. A circumferential border, such as a support tube, against which at least some of the bristles abut, may be provided within the flow channel. The circumferential border may span the cross-section of the flow channel. In other words, the circumferential border covers a cross section of the flow channel. Effluent entering the first end of the flow channel is forced to enter a first end of the circumferential border. Water containing debris is therefore prevented from bypassing the circumferential border containing the brush.

When effluent containing fibers and debris is fed through the flow channel, for example the circumferential border, the brush, for example its bristles, catch these particles and prevent them from travelling to the second end of the flow channel. Centrifugal forces due to the helical shape of the flow channel may assist in moving the particles towards a circumferential border of or within the flow channel. This centrifugal motion contributes to keeping a radially inner part of the flow channel’s cross section or the brush clean. This contributes to extending the service life of the filter assembly.

After a certain time of operation, the brush or the flow channel may become clogged. For maintenance of the filter assembly, the brush and the border, if present, are pulled out of the flow channel and replaced with a new brush and border, if applicable. Alternatively, the present brush and border may be cleaned, while assuring that no microplastics are released into a sewage system, and repositioned inside the flow channel. Since prevention of release of microplastics during cleaning may be difficult, it is preferred to dispose or recycle the old brush and border with the accumulated debris and to insert a new brush and border into the flow channel. The flow channel of the support unit may similarly be cleaned during maintenance of the filter assembly.

Replacement of the brush is easy to perform and requires little time and few or no tools. Suitable brushes are available at low cost.

A length of the brush may be at least 20 times, for example, at least 40 times, a cross-sectional width of the flow channel.

A longitudinal extension of the flow channel from the first end to the second end may be at most 1.4 times, for example at most 1.2 times, a length of the brush. For example, the brush extends all the way from the first end to the second end of the flow channel.

The brush may comprise a central cord and bristles protruding from the central cord. The central cord facilitates insertion of the brush into the flow channel. Bristles protruding radially from the cord assist in guiding particles towards a circumferential delimitation of the flow channel or a border within the flow channel.

The brush may be contained within a filter tube made from filter material, for example nonwoven filter material. For example, the brush spans across a diameter of the filter tube. In other words, the brush covers a cross section of the filter tube. The filter tube forms a border within the flow channel. Dirt in the effluent flowing into the first end of the filter tube is prevented from entering the flow channel due to the filter material. Effluent is filtered throughout the length of the filter tube. Filtered effluent may pass through the filter tube towards a circumferential delimitation of the flow channel and into an inner space of a support tube. This contributes to keeping the pressure loss low. Energy consumption for filtering the effluent may be reduced. Further, the reduced pressure loss may avoid particles from being detached from the bristles of the brush. Consequently, filtration efficiency is enhanced. A maximum pore size of the filter tube may be about 200 µm, for example about 100 µm, or for example about 50 µm. The filter tube may be circumferentially sealed against a delimitation of the flow channel at the first end.

For example, the filter tube is detachable from the support unit. This may facilitate maintenance. During maintenance, the filter tube and brush are removed from the support unit. Then, a new filter tube with a pre-inserted brush is arranged in the flow channel, e.g., by winding the filter tube and brush assembly around a support tube of the support unit.

The support unit may comprise a cylindrical support tube. The flow channel may be wound around the support tube. The support tube provides stability to the flow channel and the brush and filter tube, if present. The support tube may delimit the flow channel from an inner space of the support tube over at least part of its longitudinal extension.

For example, the support unit comprises a cover, which seals the support tube at a first face associated with the first end of the flow channel. This prevents unfiltered effluent entering the inner space of the support tube. Rather, the unfiltered effluent is forced to enter the flow channel at its first end on the outside of the support tube.

The support tube may have at least one flow opening (flow window), which fluidically connects an inner space of the support tube. The support tube may comprise longitudinal and circumferential ribs. The flow openings are formed between adjacent ribs. In other words, the open space between neighboring ribs presents the flow openings. This design keeps a large area of the support tube that is in contact with the flow channel open for filtered effluent to flow into the inner space of the support tube. Filtered effluent may pass into the inner space of the support tube through the openings between the longitudinal and circumferential ribs. Clean water may easily be drained from the inner space. At least one flow opening is provided in an end section of the flow channel associated with its second end. For example, a multitude of flow openings is provided along the length of the support tube, for example along the entire longitudinal extension of the flow channel.

The support unit may comprise a helical guiding element, which separates adjacent convolutions of the flow channel. The helical guiding element may radially protrude from a cylindrical support tube, with respect to an axis of the support tube. In other words, the helical guiding element may form a ramp, which descends along the support tube. Besides delimiting adjacent convolutions of the flow channel from one another, the helical guiding element provides stability to the brush and, if present, a filter tube within the flow channel.

The support unit may be a monolithic part, for example an injection molded plastic part. This allows for cost efficient manufacturing of the support unit. Further, assembly and maintenance of the filter assembly may be facilitated, since less separate parts need be manipulated and/or replaced.

The invention further relates to a filter module comprising a housing and a filter assembly according to the invention, as described above. For example, the filter assembly is removably arranged inside the housing. For filtration operation, the filter assembly is arranged inside the housing. For ease of maintenance, i.e., replacement of the brush, the filter assembly is removed from the housing.

The housing may have a cylindrical wall, which delimits the flow channel. For example, with respect to a common axis of the cylindrical wall and a support tube, the flow channel may be delimited towards the outside by the cylindrical wall of the housing and towards the inside at least partially be delimited by the cylindrical support tube. Adjacent convolutions of the flow channel may be delimited from one another by a helical guiding element. In other words, the housing may delimit part of a cross section of the flow channel, while the remainder of the cross section of the flow channel may be defined by the support unit.

The first end of the flow channel may be fluidically connected with an inlet port through an inlet opening in the cylindrical wall. This design may provide tangential in-feeding of raw effluent. This contributes to keep pressure loss low, when guiding the effluent into the flow channel at the first end.

The flow channel may surround an inner space, for example the inner space of a support tube. The flow channel is generally fluidically connected with the inner space. After filtration through the brush and the filter tube, if present, in the flow channel, filtered effluent enters the inner space. For example, the inner space is fluidically connected with an outlet port through an outlet opening arranged in a central portion of an end wall of the housing. This design allows for example for draining of clean water from an inner space of a cylindrical support tube.

The housing may have a removable closure. Removing the closure facilitates replacement of the brush and filter tube, if present. For example, the filter assembly may be removed from the housing when the closure is detached. The closure may be removed and installed without tools. A handle may be provided to remove and install the closure. Additionally or alternatively, a tool interface may be provided at the closure. Mating threads may be provided on the closure and the housing.

The invention also relates to the use of a filter module according to the invention, as described above, for filtering effluent of a washing machine. Thereby, the ecological impact of operating the washing machine may be reduced.

The invention further relates to a washing machine comprising a filter module according to the invention, as described above. During operation of the washing machine, less particles, such as microplastics, are fed into a sewage system. The washing machine typically comprises a water inlet for receiving clean water, a washing drum, and a water outlet for discharging wastewater. For example, the filter module is fluidically arranged between the washing drum and the water outlet. In other words, effluent of the washing drum is directed through the filter assembly prior to being discharged via the water outlet. An inlet port of the filter module may receive effluent from the drum. An outlet port of the filter module may be connected to the water outlet of the washing machine. Alternatively, the outlet port of the filter module may present the water outlet of the washing machine.

### BRIEF DESCRIPTION OF THE DRAWINGS

Other advantages and features of the invention will be appreciated from the following description of embodiments of the invention with reference to the figures of the accompanying drawings, which show significant details, and from the appended claims, which form a part of this disclosure. The individual features, as described above or explained below, may each be implemented individually or implemented together in any useful combination in variants of the invention.

FIG. 1 shows a washing machine according to the invention comprising a filter module according to the invention, in a schematic elevation view.

FIG. 2 shows a filter module according to the invention, in a schematic perspective view.

FIG. 3 shows the filter module of FIG. 2 in a schematic longitudinal section, wherein a brush is arranged within a filter tube, the brush and the filter tube being received within a helical flow channel.

FIG. 4 shows the filter tube and brush of the filter module of FIG. 3, in a schematic perspective view.

FIG. 5 shows a schematic cross section through the brush and the filter tube of FIG. 4, with particles being located near a central cord of the brush.

FIG. 6 shows a schematic cross section as in FIG. 5, with particles having travelled radially outwardly to the filter tube during use of the filter module.

### DETAILED DESCRIPTION

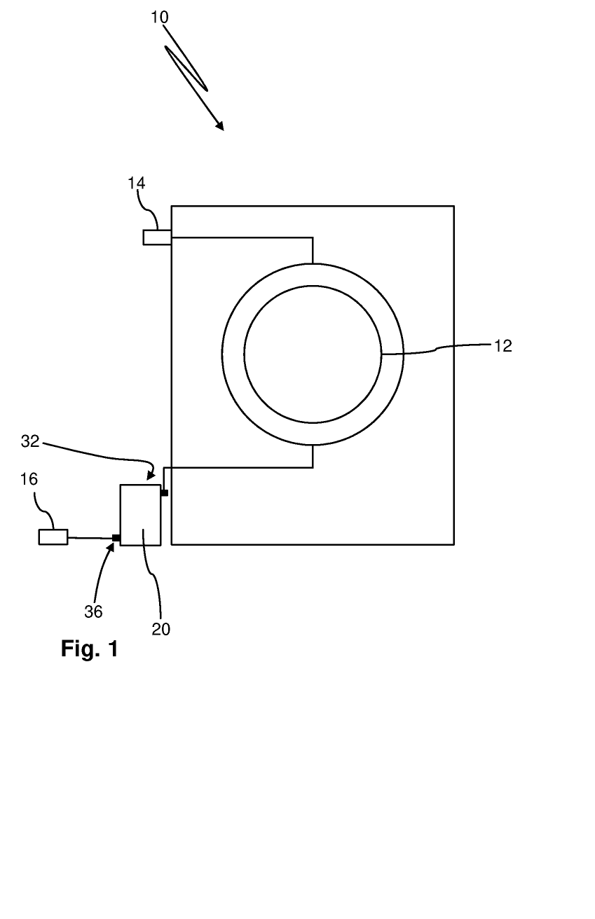

FIG. 1 shows a washing machine 10. The washing machine 10 comprises a rotatable drum 12 for receiving clothing or the like to be washed. Fresh water is fed into the drum 12 via a water inlet 14 of the washing machine 10. Wastewater (effluent) from the drum 12 is discharged into a sewage system (not depicted) via a water outlet 16 of the washing machine 10. Fluidically between the drum 12 and the water outlet 16 a filter module 20 is arranged. The filter module 20 may be arranged outside of the washing machine 10, as depicted in FIG. 1, or may be arranged within a housing of the washing machine 10 (not depicted). The filter module 20 prevents debris, which may contain microplastics, from being fed into the sewage system.

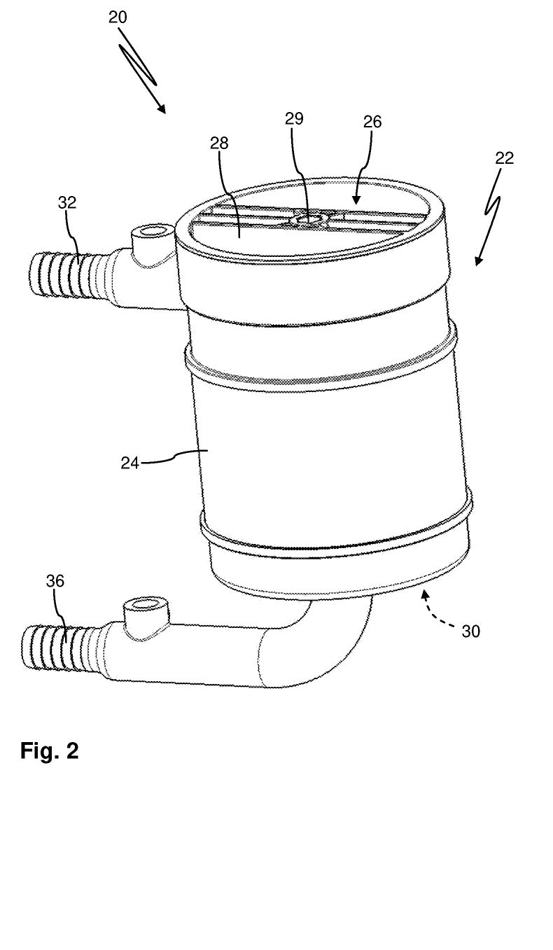

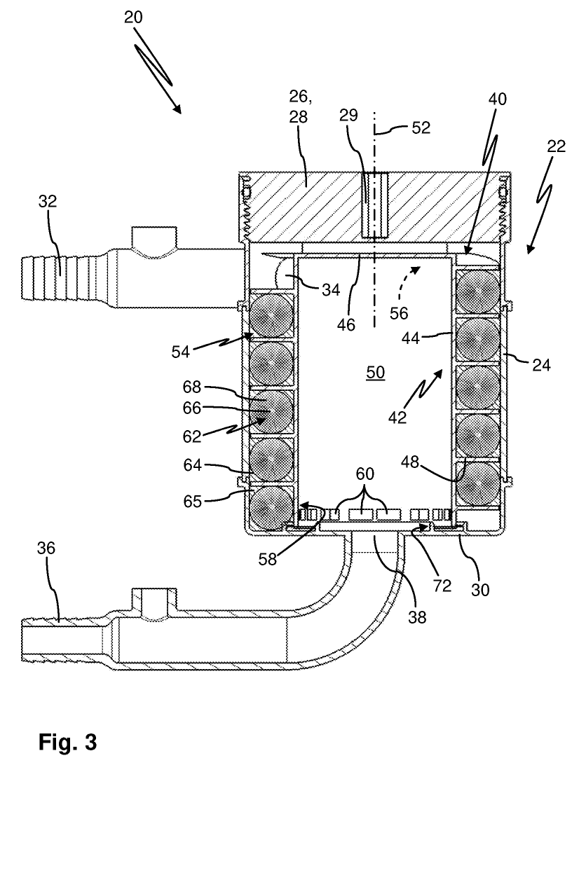

FIGS. 2 and 3 show the filter module 20 of the washing machine 10. The filter module 20 comprises a housing 22, which has a cylindrical wall 24. A removable closure 26 is attached to the cylindrical wall 24 at a top face via a threaded connection. The closure 26 is provided with a handle 28 and a tool interface 29, for removing and fastening the closure 26 from or to the cylindrical wall 24. A bottom wall or end wall 30 is provided at a bottom face of the housing 22.

An inlet port 32 allows raw effluent from the drum 12 of the washing machine 10 to be fed into the housing 22 through an inlet opening 34 in the cylindrical wall 24. An outlet port 36 allows filtered effluent to be fed to the water outlet 16 of the washing machine 10 through an outlet opening 38 in the center of end wall 30.

For removing fibers, dirt particles and debris, for example microplastics from the effluent (wastewater), a filter assembly 40 is removably arranged within the housing 22. For removing and inserting the filter assembly 40, the housing 22 is opened by detaching the closure 26.

A support unit 42 of the filter assembly 40 comprises a cylindrical support tube 44, a cover 46 and a helical guiding element 48. The support tube 44 circumferentially surrounds an inner space 50. At a first face, the cover 46 spans across the support tube 44 in order to separate the inner space 50 from an environment. The support tube 44 and the cylindrical wall 24 of the housing are arranged coaxial to one another around a common axis 52. The helical guiding element 48 radially protrudes from the support tube 44 and abuts the cylindrical wall 24 of the housing 22. The helical guiding element 48 is wound around the support tube 44. The helical guiding element 48 is inclined against the axis 52, such that it descends or ascends along the axis 52. A second face of the support tube 44 may be open; at the second face, the support tube 44 may sealingly rest on the end wall 30 of the housing 22. For example, the support tube 44 may have a catch or sealing lip (not shown) that cooperates with a corresponding groove (not shown) at the end wall 30 of the housing 22 to seal the support tube 44 against the housing 22.

Between the support tube 44 and the cylindrical wall 24 of the housing 22, the helical guiding element 48 separates adjacent convolutions (or revolutions) of a helical flow channel 54. With respect to a cross section of the helical flow channel 54, the flow channel 54 is circumferentially bounded by the support tube 44 (towards the inside with respect to the axis 52), by the cylindrical wall 24 (towards the outside with respect to axis 52), and by the helical guiding element 48 (in both directions along axis 52). In the depicted embodiment, the helical flow channel 54 comprises approiximately four and a half convolutions. The last convolution of the flow channel 54 may partially be delimited by the end wall 30 in a downward direction of axis 52.

Note that the cylindrical wall 24 of housing 22 is impermeable for effluent. The helical guiding element 48 may be permeable or for example impermeable. An impermeable guiding element 48 may sealingly abut the cylindrical wall 24 of the housing 22. The support tube 44 is generally permeable for effluent at least in sections. In other words, the helical flow channel 54 may be open towards the inner space 50 of the support tube 44.

A first end 56 of the helical flow channel 54 is associated with the inlet port 32 (note that the first end 56 is located behind the drawing plane of FIG. 3). The first end 56 may be arranged just below the cover 46. The inlet opening 34 provides fluid communication between the inlet port 32 and the first end 56 of the helical flow channel 54. The cover 46 separates the inner space 50 from the inlet opening 34 and the inlet port 32. Thus, raw effluent is introduced into the helical flow channel 54 at its first end 56.

A second end 58 of the helical flow channel 54 is associated with the outlet port 36.

At least in an end section of the helical flow channel 54, i.e. near the second face of the support tube 44, the support tube 44 is provided with flow openings 60. For example, further flow openings are provided along the support tube 44 or the helical flow channel 54, respectively (not depicted). The support tube 44 may comprise longitudinal and circumferential ribs along the radial body of the support tube 44, wherein the flow openings 60 are each provided between a pair of longitudinal ribs and a pair of circumferential ribs. The support tube 44 and the flow openings 60 provide fluid communication between the helical flow channel 54 and the inner space 50 of the support tube 44. Thus, the flow channel 54 is fluidically connected to the outlet port 36 via the flow openings 60, the inner space 50 and the outlet opening 38.

For filtering the effluent, a brush 62 is provided within the helical flow channel 54. The brush 62 extends from the first end 56 towards the second end 58, for example all the way to the second end 58.

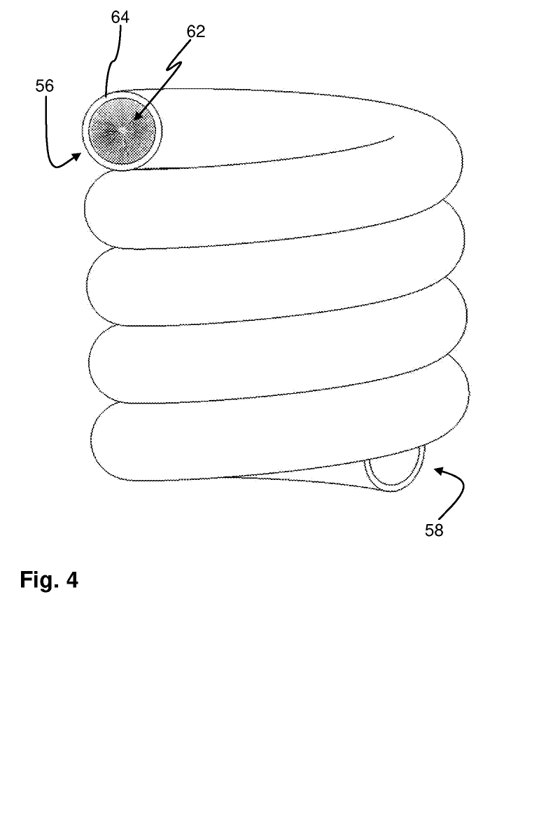

The brush 62 is arranged inside a filter tube 64, see also FIG. 4. The filter tube 64 is made from filter material, for example nonwoven filter material. The filter tube 64 is contained within the flow channel 54 and extends from the first end 56 to the second end 58.For example, the filter tube 64 is detachable from the support unit 42. At the first end 56, the filter tube 64 is circumferentially (with respect to the cross section of the flow channel 54) sealed against the delimitation of the flow channel 54. Along its extension, the filter tube 64 may fill the flow channel 54 across its cross section; in a free space 65 between the filter tube 64 and the delimitation of the flow channel 54, i.e. the support tube 44, the guiding element 48 and the cylindrical wall 24, may be filled with material of the filter tube 64, such as the nonwoven filter material.

The brush 62 comprises a central cord 66 and bristles 68, which are fixed to the central cord 66 and protrude from the central cord 66. Free ends of (at least most of) the bristles 68 abut the filter tube 64. In other words, the brush 62 covers the cross section of the filter tube 64.

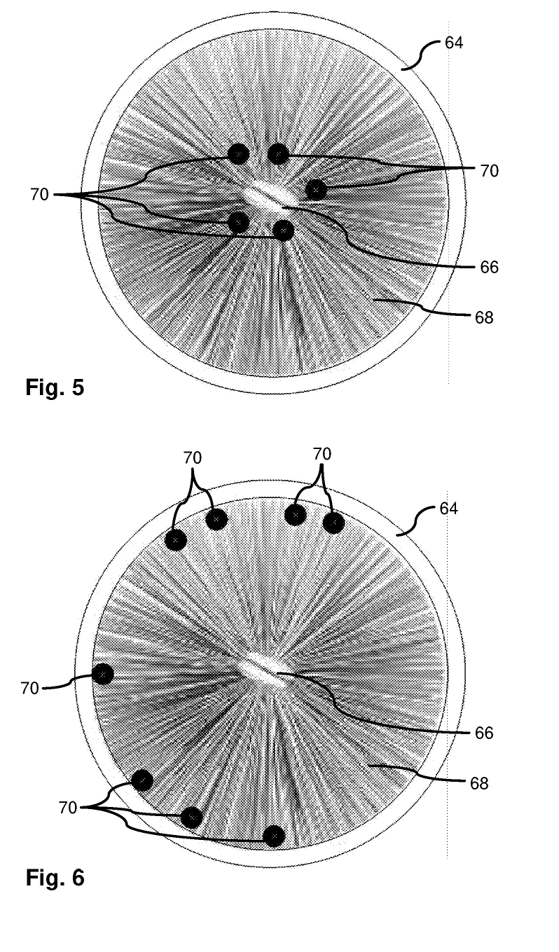

When effluent containing particles 70 such as microplastics or fibers is fed through the filter tube 64, the bristles 68 of the brush 62 capture these particles 70, see FIG. 5. While more effluent passes through the filter tube 64, the particles 70 eventually travel along the bristles 68 towards the inner surface of the filter tube 64, see FIG. 6.

The filter material of the filter tube 64 allows water to pass through, while retaining the particles 70 inside the filter tube 64. Thus, water travels along the flow channel 54 along the brush 62 within the filter tube 64. Clean water passes through the filter material of the filter tube 64 into the free space 65 between the filter tube 64 and the support unit 42 or the cylindrical housing wall 24. The clean water then flows from the free space 65 through the flow openings 60 into the inner space 50 of the support tube 44. Water which leaves the flow channel 54, has been filtered by passing through the brush 62 and/or the filter tube 64.

After some period of operation, the brush 62 or the inner surface of the filter tube 64 may become clogged with particles 70. Thus, maintenance of the filter module 20 is required.

For maintenance, the closure 26 is unscrewed and the filter module 40 is removed from the housing 22. Then, the used brush 62 and filter tube 64 are removed from the support unit 42, e.g. by unwinding them from the support tube 44. A new assembly of a brush 62 arranged in a filter tube 64 is wound around the support tube 44, so the tube-brush-assembly 62, 64 is arranged in the flow channel 54. For example the brush-tube-assembly 62, 64 may be pressed between the helical guiding element 48, for example starting from the first end 56 of the flow channel 54 while working towards the second end 58. The filter assembly 40 is put back into the housing 22, while assuring that the closed end (i.e. cover 46) of the support tube 44 faces away from the end wall 30. A protrusion 72 on the end wall 30 may prevent full insertion of the filter assembly 40 in upside down orientation, compare FIG. 3. Fully tightening the closure 26 is for example possible only if the filter assembly 40 is installed in the proper orientation, i.e. with cover 46 facing the closure 26.

In summary, a filter for effluent of washing machines comprises a helical flow channel. An elongate brush extends along the flow channel.For example, the

brush is contained within a filter tube. The brush may be replaced, while the filter tube is generally reused with a new brush. The brush and the filter tube capture fibers and particles such as microplasics, when effluent is fed through the flow channel. A support unit may at least partially define the cross section of the flow channel.For example, the support unit is detachably arranged in a housing.

Washing machine 10

Drum 12

Water outlet 16

Filter module 20

Housing 22

Cylindrical wall 24

Closure 26

Handle 28

Tool interface 29

End wall 30

Inlet port 32

Inlet opening 34

Outlet port 36

Outlet opening 38

Filter assembly 40

Support unit 42

Support tube 44

Cover 46

Guiding element 48

Inner space 50

Axis 52

Flow channel 54

First end 56

Second end 58

Flow openings 60

Brush 62

Filter tube 64

Free space 65

Central cord 66

Bristles 68

Particles 70

Protrusion 72

That which is claimed is:

1. A filter assembly, for filtering effluent of a washing machine, the filter assembly comprising:
a support unit, providing a helical flow channel having a first end and a second end;
a brush, detachably arranged in the helical flow channel and extending along the flow channel over at least part of a longitudinal extension of the flow channel from the first end towards the second end.

2. The filter assembly according to claim 1, wherein the brush comprises a central cord and bristles protruding from the central cord.

3. The filter assembly according to claim 1, wherein the brush is contained within a filter tube made from filter material.

4. The filter assembly according to claim 3, wherein the filter tube is detachable from the support unit.

5. The filter assembly according to claim 1, wherein the support unit comprises a cylindrical support tube, and wherein the flow channel is wound around the support tube.

6. The filter assembly according to claim 5, wherein the support unit comprises a cover, which seals the support tube at a first face associated with the first end of the flow channel.

7. The filter assembly according to claim 5, wherein the support tube has at least one flow opening, which fluidically connects an inner space of the support tube with the flow channel.

8. The filter assembly according to claim 1, wherein the support unit comprises a helical guiding element, which separates adjacent convolutions of the flow channel.

9. A filter module comprising a housing and the filter assembly according to claim 1, and wherein the filter assembly is removably arranged inside the housing.

10. The filter module according to claim 9, wherein the housing has a cylindrical wall, which delimits the flow channel.

11. The filter module according to claim 10, wherein the first end of the flow channel is fluidically connected with an inlet port through an inlet opening in the cylindrical wall.

12. The filter module according to claim 9, wherein the flow channel surrounds an inner space, which is fluidically connected with the flow channel, and wherein the inner space is fluidically connected with an outlet port through an outlet opening arranged in an end wall of the housing.

13. The filter module according to claim 9, wherein the housing has a removable closure.

14. The use of the filter module according to claim 9 for filtering effluent of a washing machine.

15. A washing machine comprising the filter module according to claim 9.
